(19) United States
(12) Patent Application Publication
(10) Pub. No.: US 2010/0225224 A1
(43) Pub. Date: Sep. 9, 2010

(54) FLUORESCENT MATERIAL AND FLUORESCENT LAMP USING THE SAME

(75) Inventors: Te-Wen KUO, Hsinchu (TW); Teng-Ming Chen, Hsinchu (TW)

Correspondence Address: RABIN & Berdo, PC, 1101 14TH STREET, NW, SUITE 500, WASHINGTON, DC, 20005, US

(73) Assignee: LITE-ON IT CORPORATION, Hsinchu (TW)

(21) Appl. No.: 12/568,417

(22) Filed: Sep. 28, 2009

(30) Foreign Application Priority Data
Mar. 5, 2009 (CN) 200910126168.6

(51) Int. Cl. H01J 63/04; C09K 11/70

(52) U.S. Cl. 313/486; 252/301.4 P; 252/301.6 P

(57) ABSTRACT

A fluorescent material is provided. The fluorescent material is expressed as: A₃D_{1-X}(PO₄)₃:Ce_{X}, wherein, 0<X≦0.5, “A” is selected from Be, Mg, Ca, Sr, Ba, Zn or a combination thereof, and “D” is selected from La, Gd, Y, Sc, Lu, Nd, B, Al, Ga, In or a combination thereof.

This application claims the benefit of People's Republic of China application Serial No. 200910126168.6, filed Mar. 5, 2009, the subject matter of which is incorporated herein by reference.

### BACKGROUND OF THE INVENTION

1. Field of the Invention

The invention relates in general to a fluorescent material and a fluorescent lamp using the same, and more particularly to a fluorescent material doped with a small amount of rear-earth elements and a fluorescent lamp using the same.

2. Description of the Related Art

The fluorescent lamp (also called as the daylight lamp, the tube, and the fluorescence tube) is an illuminating device, which uses power to excite mercury vapor from the gas of argon or neon to form plasma and emit a short-wave ultraviolet so that the fluorescent material inside the tube emits visible light for illumination. The colors of the lights emitted by different types and mixture ratios of fluorescent materials are different accordingly. Thus, the fluorescent material is a key factor in determining the fields of application of the fluorescent lamp.

Currently, the fluorescent lamp used for tanning the skin is normally equipped with a direct pigmentation spectrum 5031 and mainly emits a UV-A ray whose wavelength ranges between 320 nm-340 nm as well as a small flux of UV-B radiation light whose wavelength ranges between 260 nm-320 nm. The UV-B radiation causes skin to form melanin, and when used together with the UV-A radiation, the two radiations can further darken the melanin form inside the skin and make the skin tanned. The phosphor powder used in the tanning lamp is BaSi₂O₅:Pb, which mainly emits a UV-A ray whose wavelength is 351 nm. As the phosphor powder contains a poisonous metal, that is, lead, the fluorescent material once leaked will cause harm to the user and the environmental ecology. Therefore, there are lead-free phosphor powders such as YPO₄:Ce, SrB₄O₇:Eu, (Ba, Mg)Al₁₁O₁₉:Ce available in the market. These phosphor powders are lead-free and can emit a UV-A radiation light. As these phosphor powders all use expensive rare-earth metals such as Ce and Eu as an activator, these phosphor powders involve high manufacturing costs and are thus hard to be widely used.

Moreover, the fluorescent material inside an ordinary fluorescent lamp or a cold cathode fluorescent lamp already mixes the red, the green and the blue fluorescence. On the part of the fluorescent material, the fluorescent material for emitting green fluorescence affects the luminous flux and color rendering of the fluorescent lamp most, and is the most expensive of the three kinds of fluorescent materials. The green phosphor powders currently available in the market are divided into two categories, one is mainly based on phosphate and the other is mainly based on aluminum oxide. Examples of the groups are LaPO₄:Ce,Tb and CeMgAl₁₁O₁₉:Tb. The group based on phosphate has stronger luminous intensity and is thus become a preferred green fluorescent material. The green phosphor powder LaPO₄:Ce,Tb emits a green fluorescence with stronger intensity, but needs to be doped with expensive rare-earth metals such as Ce and Tb as an activator. Therefore, the manufacturing costs are too high to become popular.

### SUMMARY OF THE INVENTION

The invention is directed to a fluorescent material and a fluorescent lamp using the same. The fluorescent material is doped with a small amount of rare metals and the manufacturing cost for the fluorescent lamp is low.

According to a first aspect of the present invention, a fluorescent material is provided. The fluorescent material is expressed as:

A₃D_{1-X}(PO₄)₃:Ce_{X}

Wherein, 0<X≦0.5, “A” is selected from the group consisting of Be, Mg, Ca, Sr, Ba, Zn or a combination thereof, and “D” is selected from the group consisting of La, Gd, Y, Sc, Lu, Nd, B, Al, Ga, In or a combination thereof.

According to a second aspect of the present invention, a fluorescent lamp is provided. The fluorescent lamp comprises a glass tube and a fluorescent film. The glass tube is filled with mercury and inert gases, and the fluorescent film is formed on the inner side of the glass tube. The fluorescent film at least comprises a fluorescent material which is expressed as:

A₃D_{1-X}(PO₄)₃:Ce_{X}

Wherein, 0<X≦0.5, “A” is selected from the group consisting of Be, Mg, Ca, Sr, Ba, Zn or a combination thereof, and “D” is selected from the group consisting of La, Gd, Y, Sc, Lu, Nd, B, Al, Ga, In or a combination thereof.

The invention will become apparent from the following detailed description of the preferred but non-limiting embodiments. The following description is made with reference to the accompanying drawings.

### BRIEF DESCRIPTION OF THE DRAWINGS

FIG. 1 shows a emission spectrum of a fluorescent material with different Ce doping ratios X according to a first embodiment of the invention;

FIG. 2 shows a X-ray diffraction pattern of a fluorescent material according to a first embodiment of the invention;

FIG. 3 shows an excitation spectrum of a fluorescent material according to a first embodiment of the invention;

FIG. 4 shows an emission spectrum of a fluorescent material according to a first embodiment of the invention;

FIG. 5 shows a comparison of emission spectrum between a fluorescent material of a first embodiment of the invention and a conventional UV-A phosphor powder;

FIG. 6 shows a cross-sectional view of a fluorescent lamp according to a first embodiment of the invention;

FIG. 7 shows an emission spectrum of a fluorescent material with different Ce doping ratios Y according to a second embodiment of the invention;

FIG. 8 shows a comparison of X-ray diffraction pattern between a fluorescent material of a second embodiment of the invention and a standard pattern of Sr₃La(PO₄)₃; and

FIG. 9 shows a comparison of emission spectrum between a fluorescent material of a second embodiment of the invention and a conventional green phosphor powder.

### DETAILED DESCRIPTION OF THE INVENTION

The invention provides a fluorescent material, in which the main substance, i.e., phosphate, is doped with a small amount of Ce element as an activator, so as to emit a light with effective luminous intensity. Several embodiments accompanied by drawings and experiments are exemplified below for elaboration. However, anyone who is skilled in the technology of the invention will understand that these embodiments are only a few implementations under the spirit of the invention, and the texts and drawings used in the disclosure are not for limiting the scope of protection of the invention.

### First Embodiment

The present embodiment of the invention provides a fluorescent material for emitting UV-A ray, whose illuminating wavelength is within the range from 320 nm to 400 nm. The fluorescent material of the present embodiment of the invention is expressed as formula [1]:

A₃D_{1-X}(PO₄)₃:Ce_{X} [1]
0<X≦0.5

“A” is selected from the group consisting of beryllium (Be), magnesium (Mg), calcium (Ca), strontium (Sr), barium(Ba), zinc(Zn) or a combination thereof, and “D” is selected from the group consisting of lanthanum (La), gadolinium (Gd), yttrium(Y), scandium (Sc), lutetium (Lu), neodymium (Nd), boron (B), aluminium (Al), gallium (Ga), indium (In), or a combination thereof. The fluorescent material of the present embodiment uses a metal phosphate as the main substance. “A” denotes a positively bivalent metal ion comprising an alkaline-earth metal or a transition metal. “A” can be a metal ion of one element of Be, Mg, Ca, Sr, Ba and Zn, or a combination of two or more than two elements thereof. Likewise, “D” is a positively trivaleant metal ion comprising a poor metal or a rare-earth metal. “D” can be a metal ion of one element of La, Gd, Y, Sc, Lu, Nd, B, Al, Ga and In, or a combination of two or more than two elements thereof.

Besides, photoluminescence effect can be achieved by adding a transition metal or a rare-earth metal to a phosphate lattice as an activator. Thus, the fluorescent material of the present embodiment of the invention is doped with a rare-earth metal, i.e., Ce, as an activator. The content of dopped Ce element (X) in each mole of fluorescent material is greater than 0 mole but smaller than or equal to 0.5 mole; preferably X ranges from 0.03 to 0.12 mole. That is, if the positively trivalent metal ion “D” and Ce element add up to 1 mole, then the content of Ce is smaller than 0.5 moles and preferably ranges between 0.03 and 0.12 moles.

In a preferred embodiment, the “A” element in the formula [1] is Sr, the “D” element is La, and each mole of fluorescent material includes 3 moles of Sr, 3 moles of phosphate, and 1 mole of La and Ce. Based on the above disclosure, the fluorescent material of the present preferred embodiment is expressed as formula [1-1]:

Sr₃(La_{1-X}Ce_{X})(PO₄)₃ [1-1]

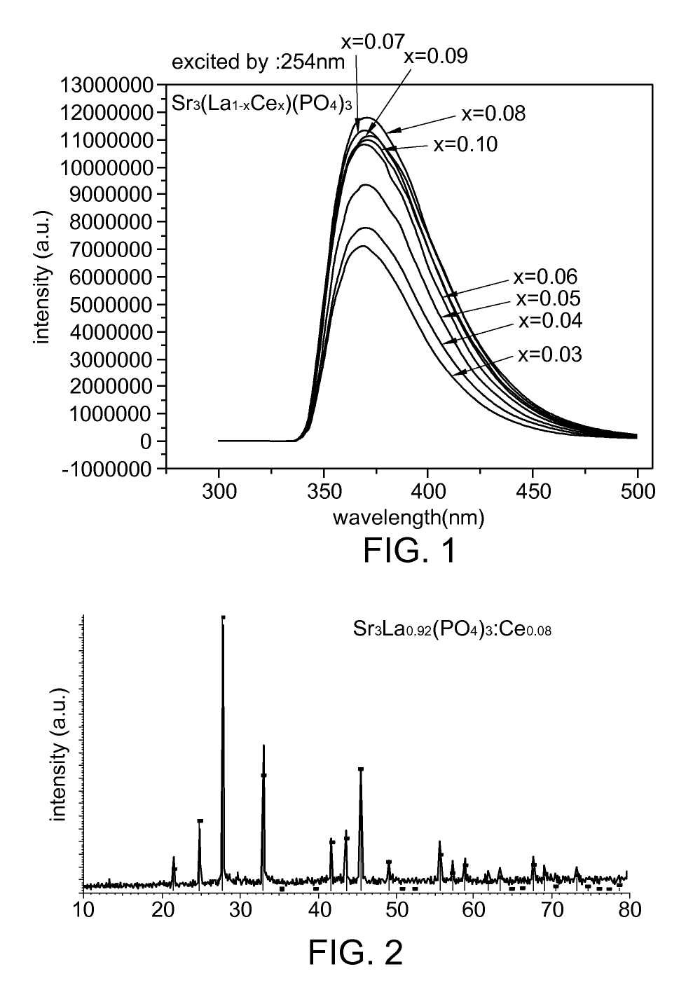

After element type is confirmed, a preferred doping ratio of Ce element is obtained from experimental results. Different fluorescent materials are synthesized by fixing the mole numbers of Sr, phosphate (PO₄³⁻) and the sum of La and Ce and adjusting relative mole ratio between La and Ce. The present experiment provides eight kinds of fluorescent materials, each mole of which includes 0.03, 0.04, 0.05, 0.06, 0.07, 0.08, 0.09, 0.10 moles of Ce and 0.97, 0.96, 0.95, 0.94, 0.93, 0.92, 0.91, 0.90 moles of La, respectively. The details of the above synthesizing method are disclosed below. Then, the emission spectrums of each fluorescent material with different Ce doping ratios X are measured and shown in FIG. 1.

FIG. 1 shows an emission spectrum of a fluorescent material with different doping ratios X of Ce element according to the first embodiment of the invention. Referring to FIG. 1, when the fluorescent material is excited by 254 nm ultraviolet light, the fluorescent material doped with different ratios of Ce is capable of emitting a UV-A ray whose wavelength ranges between 320 nm˜400 nm, and the main illuminating wavelength is about 370 nm, wherein X ranges between 0.03˜0.10. Moreover, as indicated in FIG. 1, the doping mole ratio of Ce affects the luminous intensity of fluorescent material. When the content of Ce element(X) in each mole of fluorescent material is 0.08 mole, the luminous intensity is the strongest of the eight kinds of fluorescent materials with different mixture ratios. Thus, each mole of fluorescent material of the present preferred embodiment preferably contains 0.08 moles of Ce element, and the fluorescent material of the present preferred embodiment is expressed as formula [1-2]:

Sr₃La_{0.92}(PO₄)₃:Ce_{0.08} [1-2]

Anyone who is skilled in the technology of the invention will understand that when the composition of fluorescent material changes, the preferred doping ratio of Ce element also changes accordingly. For example, of the fluorescent material of the present preferred embodiment, “A” denotes Sr, “D” denotes La, and the cotent of Ce element (X) doped each mole of fluorescent material is preferably 0.08 moles. However, when “A” changes to a combination of Sr and Ba, and “D” remains being La, the preferred range of X may remain the same or may change. As possible elements of “A” and “D” and the method of obtaining a preferred doping ratio of Ce element are already provided in the specification of the present application, anyone who is skilled in the technology of the invention will be able to obtain the preferred doping ratio of Ce element of various fluorescent materials according to the disclosure in the specification of the present patent.

The fluorescent material of the present preferred embodiment can be manufactured according to formula [1-3], and the details of synthesizing procedures are disclosed below.

3SrCO₃+½La₂O₃+3(NH₄)₂HPO₄+CeO₂→Sr₃La(PO₄)₃:Ce³⁺ [1-3]

Firstly, strontium carbonate (SrCO₃), lanthanum oxide (La₂CO₃), ammonium dihydrogen phosphate ((NH₄)₂HPO₄) and cerium oxide (CeO₂) are weighed according to the ratio given in formula [1-3]. Next, the chemical compounds are mixed and grinded for 10-30 minutes. Then, the grinded powder is placed in a crucible, which is then placed in a high-temperature furnace. After that, a reducing gas (such as hydrogen, argon, and nitrogen) is infused into the furnace. After 6-8 hours of sintering under the temperature of 1200° C.˜1600° C., the fluorescent material of the present preferred embodiment Sr₃La_{0.92}(PO₄)₃:Ce_{0.08} will thus be obtained. The doping ratio of any element can be changed by adjusting the weight of the element being used.

The properties of the fluorescent material Sr₃La_{0.92}(PO₄)₃:Ce_{0.08} of the preferred embodiment including X-ray diffraction pattern, excitation spectrum and emission spectrum are analyzed below.

Which mineral crystallization or crystal material that the to-be-tested material belong to can be determined according to the X-ray diffraction pattern. When the X-ray diffractor radiates the crystal with an X-ray, a diffraction wave occurs to only some particular incident angles, and this is determined according to the shape, the size and the symmetry of unit cell. Moreover, different atoms have different levels of scattering ability of X-ray. Thus, when the constituting atoms of unit cell are different, the same structure may result in different levels of diffraction intensity. The X-ray diffraction experiment of crystal provides two important items of information: one is the position of the diffraction peak, that is, 2θ, and the other is the intensity (I) of the diffraction peak. The first item of information provides the information regarding the shape and the size of the unit cell of crystal (that is, the lattice parameters), and the second item of information provides the information regarding the types and position of the atoms constituting the crystal. When the structure and the constitution of the crystal of the material change, the above two items of information for each crystal are different just like different people have different fingerprints. Thus, which type of mineral crystallization or crystal material a particular material belongs to can be determined according to the X-ray diffraction analysis.

When the material is diffracted by X-ray, different crystal compounds will generate different (2θ, I) combinations and form a diffraction pattern. The X-ray diffraction pattern can be used for calibrating the lattice constants and verifying the crystal phase. Referring to FIG. 2, an X-ray diffraction pattern of a fluorescent material Sr₃La_{0.92}(PO₄)₃:Ce_{0.08} according to the first embodiment of the invention is shown. The horizontal axis is the position (the unit is 2θ) of diffraction peak, and the vertical axis is the intensity (the unit is arbitrary unit (a.u.)) of diffraction peak. The diffraction peak position of the X-ray diffraction pattern being measured is compared with the database to prove that the crystal of the fluorescent material of the present preferred embodiment being synthesized is constituted by Sr, La, phosphate (PO₄) and Ce.

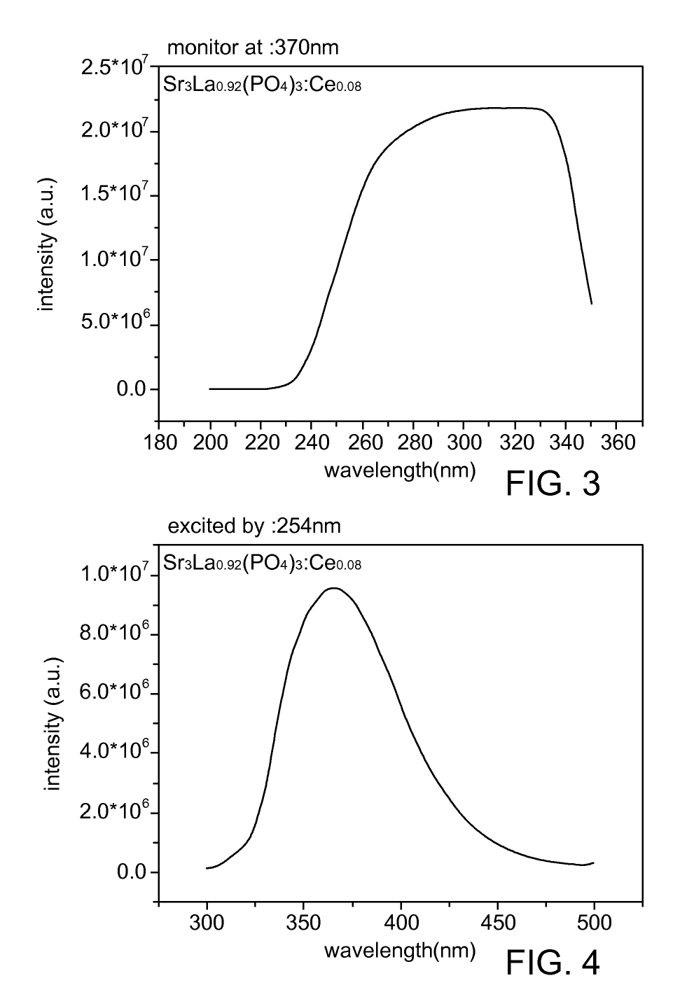

What wavelength range of light source can be used as the excitation source of the fluorescent material of the present preferred embodiment can be determined from the excitation spectrum. In the present experiment, the light source with different wavelengths is used for exciting the fluorescent material of the present preferred embodiment Sr₃La_{0.92}(PO₄)₃:Ce_{0.08}, and how much fluorescence intensity of 370 nm can be emitted from the fluorescent material excited by the light source with different wavelengths is measured and recorded in FIG. 3. FIG. 3 shows an excitation spectrum of a fluorescent material Sr₃La_{0.92}(PO₄)₃:Ce_{0.08} according to the first embodiment of the present disclose. The horizontal axis denotes the wavelength (the unit is nm) of the light source for excitation, the vertical axis denotes the fluorescence intensity (the unit is arbitrary unit (a.u.)) emitted from the excited fluorescent material. As indicated in FIG. 3, the fluorescent material of the present preferred embodiment emits a light within the range of UV-A when excited by an excitation source whose wavelength ranges between 240 nm and 340 nm. As the wavelength of the excitation source ranges between 240 nm and 340 nm and falls within the ultraviolet range, the fluorescent material of the present preferred embodiment can be used in the illuminating device such as the daylight lamp, the fluorescent lamp and the tanning lamp, in which mercury vapor is used as the excitation source.

It can be inferred from the emission spectrum with respect to the wavelength and relative intensity of the fluorescence emitted by the excited fluorescent material of the present preferred embodiment. In the present experiment, an excitation source of 254 nm is applied to excite the fluorescent material, and the wavelength and the intensity of the light emitted by the excited fluorescent material is measured and recored in FIG. 4. FIG. 4 shows a emission spectrum of a fluorescent material Sr₃La_{0.92}(PO₄)₃:Ce_{0.08} according to the first embodiment of the invention. The horizontal axis denotes the wavelength (nm) of the light source for excitation, the vertical axis denotes the fluorescence intensity (a.u.) emitted from the excited fluorescent material. As indicated in FIG. 4, the excited fluorescent material of the present preferred embodiment can emit a light whose wavelength ranges between 320 nm and 400 nm. The main wavelength of the emission is about 370 nm and belongs to a UV-A radiation light.

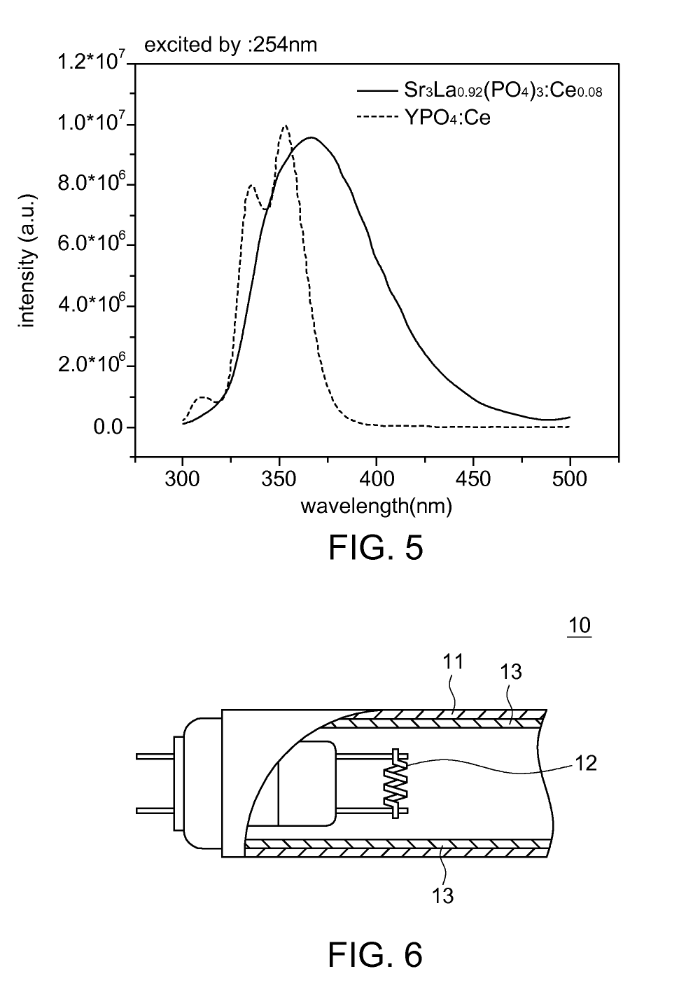

The emission properties and the doped amount of rare-earth metals of a conventional phosphor powder are compared with that of the fluorescent material of the present preferred embodiment. The conventional phosphor powder is exemplified by a UV-A product, that is, YPO₄:Ce phosphor powder, manufactured by the Nichia Corporation, wherein the doped molecular ratio between Y and Ce is 0.8:0.2 in each mole of phosphor powder. FIG. 5 shows a comparison of emission spectrum between a fluorescent material of the first embodiment of the present dislcosure and a conventional UV-A phosphor powder. The conventional phosphor powder YPO₄:Ce emits a light whose main wavelength is 352 nm, the fluorescent material of the present preferred embodiment emits a light whose main wavelength is 370 nm. Both fluorescent materials can emit a UV-A ray with similar luminous intensity.

Referring to Table 1, each kilogram of conventional phosphor powder YPO₄:Ce must be doped with 144 grams of Ce element, but each kilogram of the fluorescent material of the present preferred embodiment Sr₃La(PO₄)₃:Ce only needs to be doped with 16.3 grams of Ce element, which is only 11.32% of the amount doped in conventional phosphor powder. Compared with the conventional phosphor powder, the fluorescent material of the present preferred embodiment only needs to be doped with a small amount of Ce element (is about 1/9) in order to emit a UV-A ray with similar intensity.

TABLE 1
A comparison between the amount of Ce doped in conventional
phosphor powder and the amount of Ce doped in the fluorescent
material of the present embodiment of the invention.

| | | The Fluorescent material Of The |
|---|---|---|
| | Conventional Phosphor | Present Embodiment Of The |
| | Powder | Invention |
| Formula | Y_{0.8}PO₄:Ce_{0.2} | Sr₃La_{0.92}(PO₄)₃:Ce_{0.08} |
| Molecular | 194.2 | 688.08 |
| Weight | | |
| Ce Doped | 144 g/1 kg of Phosphor | 16.3 g/1 kg of Fluorescent |
| Amount | Powder | material |

The rare-earth metals are expensive. If the doped amount of Ce element is reduced, the manufacturing cost of the fluorescent material can be greatly reduced. It allows the manufacturing cost of the fluorescent material of the present preferred embodiment to be reduced to be 40% of the manufacturing cost of the conventional phosphor powder.

FIG. 6 shows a cross-sectional view of a fluorescent lamp according to the first embodiment of the invention. The present embodiment provides a fluorescent lamp 10 using the above fluorescent material. The fluorescent lamp 10 includes a glass tube 11, a fluorescent film 13 and a filament coil 12. The glass tube 11 is filled with mercury and inert gases, and the two ends of the glass tube 11 respectively have a filament coil 12 made from wolfram. The fluorescent film 13 is formed on the inner side of the glass tube 11 and at least comprises the abovementioned fluorescent material.

After the power is turned on, firstly, a current flows through and heats the filament 12 for releasing electrons, converting the inert gases and mercury vapor inside the glass tube 11 into plasma to increase the current inside the glass tube 11. When the voltage between two sets of filaments 12 exceeds a predetermined value, the tube starts to discharge and make the mercury vapor emit an ultraviolet whose wavelength is 253.7 nm and 185 nm. According to the excitation spectrum of FIG. 3 and the emission spectrum of FIG. 4, the fluorescent film 13 disposed on the inner surface of the glass tube 11 can absorb the ultraviolet whose wavelength is 253.7 nm and then release a UV-A ray whose wavelength ranges between 320 nm and 400 nm.

The fluorescent lamp 10 of the present preferred embodiment can be used in compact fluorescent lamp (CFL), hot cathode fluorescent lamp (HCFL), cold cathode fluorescent lamp (CCFL), low-pressure mercury (vapor) discharge lamp, the tanning lamp, mosquito catcher and so on.

### Second Embodiment

The present embodiment of the invention provides a fluorescent material, which differs with the above embodiment in that the fluorescent material of the present embodiment of the invention is further doped with terbium (Tb) for emitting a green fluorescence. The fluorescent material of the present embodiment is expressed as formula [2]:

A₃D_{1-X-Y}(PO₄)₃:Ce_{X}, Tb_{Y} [2]
0<X≦0.5
0<Y≦0.6

As disclosed above, A₃D_{1-X-Y}(PO₄)₃:Ce_{X} can absorb an ultraviolet light whose wavelength is 254 nm, and release a UV-A ray whose wavelength ranges 320 nm and 400 nm. The fluorescent material of the present embodiment is further doped with Tb as an activator. Tb element can absorb the UV-A ray released from the abovementioned material and then release a green fluorescence whose wavelength ranges between 525 nm and 575 nm. The content of Tb element (Y) doped in each mole of fluorescent material should be smaller than or equal to 0.6 moles, and preferably is smaller than 0.4 moles.

Likewise, the content of Ce element (X) doped in each mole of fluorescent material should be smaller than or equal to 0.5 moles, wherein X preferably ranges between 0.03 and 0.1. “A” is selected from the group consisting of Be, Mg, Ca, Sr, Ba, Zn or a combination thereof, and “D” is selected from the group consisting of La, Gd, Y, Sc, Lu, Nd, B, Al, Ga, In or a combination thereof.

In formula [2] of the present preferred embodiment, “A” denotes Sr, “D” denotes La, and each mole of fluorescent material comprises 3 moles of strontium (Sr), 3 moles of phosphate (PO₄³⁻), and 1 mole of La, Ce and Tb. As is disclosed in the first embodiment, when the mole doping ratio between La and Ce in each mole of fluorescent material is 0.92:0.08, the luminous intensity is the strongest. Thus, in the following experiments, the mole numbers of Sr, phosphate (PO₄³⁻) and the addition of La, Ce and Tb are fixed, wherein each mole of fluorescent material by all means includes 0.08 moles of Ce, then relative mole ratio between La and Tb is adjusted so as to synthesize different green fluorescent materials. As each fluorescent material by all means comprises 0.08 mole of Ce, the fluorescent material of the present preferred embodiment is expressed as formula [2-1]:

Sr₃(La_{0.92-Y}Ce_{0.08}Tb_{Y})(PO₄)₃ [2-1]

The fluorescent material of the present preferred embodiment can be manufactured according to formula [2-2], and the details of synthesizing procedures are disclosed below.

3SrCO₃+½La₂O₃+3(NH₄)₂HPO₄+CeO₂+TbO₇→Sr₃La(PO₄)₃:Ce³⁺,Tb³⁺ [2-2]

Firstly, strontium carbonate (SrCO₃), lanthanum oxide (La₂CO₃), ammonium dihydrogen phosphate ((NH₄)₂HPO₄), cerium oxide (CeO₂) and terbium oxide (TbO₇) are weighed according to a predetermined ratio. Next, the chemical compounds are mixed and grinded for 10-30 minutes. Then, the grinded powder is placed in a crucible, which is then placed in a high-temperature furnace. After that, a reducing gas (such as hydrogen, argon, and nitrogen) is infused into the furnace. After 6-8 hours of sintering under the temperature of 1200° C.˜1600° C., the fluorescent material of the present preferred embodiment Sr₃La_{1-X-Y}(PO₄)₃: Ce_{X}, Tb_{Y} will thus be obtained. The doping ratio of anyone element can be changed by adjusting the weight of the element being used.

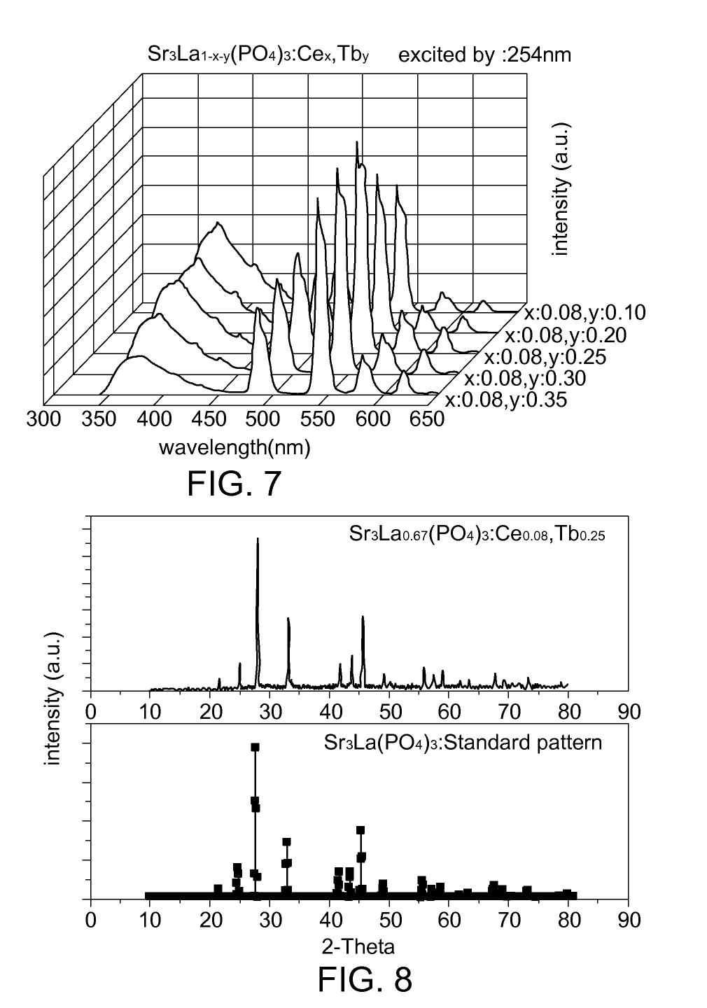

By taking the fixed mole amount of Ce as 0.08 mole, the present experiment provides five kinds of fluorescent materials, each mole of which includes 0.1, 0.2, 0.25, 0.3, 0.35 moles of Tb and 0.82, 0.72, 0.67, 0.62, 0.57 moles of La respectively. After the five kinds of fluorescent materials manufactured according to the above method are respectively excited by a 254 nm ultraviolet, their emission spectra are measured and illustrated in FIG. 7. Then, a preferred relative ratio for Tb to be doped in La and Ce is obtained from the results of experiments.

FIG. 7 shows an emission spectrum of a fluorescent material with different Ce doping ratios (Y) according to the second embodiment of the invention. Referring to FIG. 7, all the fluorescent materials doped with Tb can emit a green fluorescence whose wavelength ranges from 525 nm to 575 nm, the main wavelength of the light being emitted is about 540 nm, wherein the doped ration of Tb (Y) ranges between 0.1˜0.35. As is indicated in FIG. 7, the luminous intensity of the fluorescent material is affected by the doping ratio of Tb element, when the content of Tb element (Y) doped in each mole of fluorescent material is 0.25 moles, the luminous intensity is the strongest of the five kinds of fluorescent material. Thus, the content of Tb element (Y) doped in each mole of the fluorescent material of the present preferred embodiment is 0.25 moles, and the doping ratios of Ce and La are preferably 0.08 and 0.67 respectively. The fluorescent material of the present preferred embodiment is expressed as formula [2-3]:

Sr₃La_{0.67}(PO₄)₃:Ce_{0.08}, Tb_{0.25} [2-3]

Besides, the fluorescent material of the present embodiment can emit a green fluorescence regardless of what doping ratio (Y ranges between 0.1˜0.35) Tb element is. Referring to Table 2, when the doping ratio of Tb element (Y) in each mole of fluorescent material ranges between 0.1 and 0.35, the excited fluorescent materials can emit a green fluorescence.

TABLE 2
the CIE chromaticity of the illuminating fluorescent
material with different doping ratios according to
a second embodiment of the invention is shown.

Co-ordinates of
CIE Chromaticity

| Fluorescent material | X | Y |
|---|---|---|
| Sr₃La_{0.82}(PO₄)₃:Ce_{0.08}, Tb_{0.10} | 0.30 | 0.44 |
| Sr₃La_{0.72}(PO₄)₃:Ce_{0.08}, Tb_{0.20} | 0.31 | 0.48 |
| Sr₃La_{0.67}(PO₄)₃:Ce_{0.08}, Tb_{0.25} | 0.33 | 0.53 |
| Sr₃La_{0.62}(PO₄)₃:Ce_{0.08}, Tb_{0.30} | 0.33 | 0.53 |
| Sr₃La_{0.57}(PO₄)₃:Ce_{0.08}, Tb_{0.35} | 0.33 | 0.54 |

However, anyone who is skilled in the technology of the invention will understand that when the element combination of fluorescent material changes, preferred doping ratio of Tb element (Y) will change accordingly. As possible elements of “A” and “D” and the method of obtaining a preferred doping ratios of Ce element and Tb element (X) and (Y) are already provided in the specification of the present patent, anyone who is skilled in the technology of the invention will be able to obtain the preferred doping ratios of various fluorescent materials according to the disclosure in the specification of the present patent.

The properties of the fluorescent material Sr₃La_{0.67}(PO₄)₃:Ce_{0.08}, Tb_{0.25} of the preferred embodiment including X-ray diffraction pattern and emission spectrum are analyzed below. Also, a phosphate fluorescence which emits a green fluorescence and has a stronger luminous intensity, that is, the green phosphor powder La_{0.6}PO₄:Ce_{0.25}, Tb_{0.15} obtained from The Nichia Corporation of Japan, is used as a contrast group for comparison.

Referring to FIG. 8, a comparison of X-ray diffraction pattern between a fluorescent material of the second embodiment of the invention and standard pattern of Sr₃La(PO₄)₃ is shown. The horizontal axis denotes the position (the unit is 2θ) of the diffraction peak, the vertical axis denotes the intensity (the unit is arbitrary unit (a.u.)) of the diffraction peak. The position of the diffraction peak of the X-ray diffraction pattern being measured is compared with the X-ray diffraction pattern available in the market. The two spectrum patterns are similar, so it can be concluded that the crystal of the fluorescent material synthesized in the present preferred embodiment is consisted of Sr, La, phosphate (PO₄), Ce and Tb.

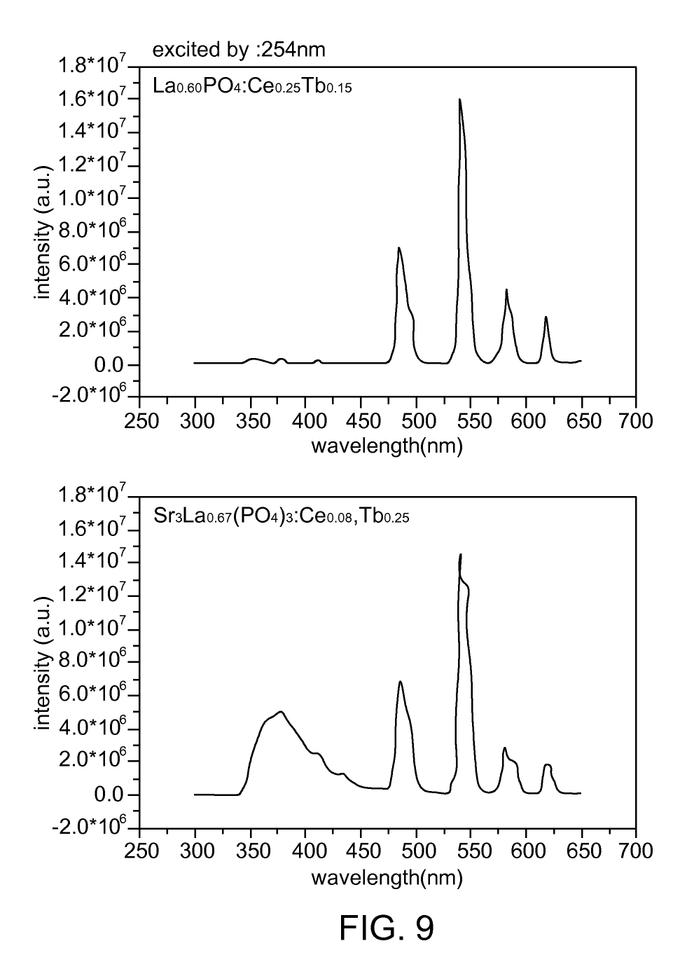

Besides, in the present experiment, the fluorescent material is excited by a 254 nm excitation source, the wavelength and the intensity of the light emitted by the excited fluorescent material, and the emission spectra is illustrated in FIG. 9, which shows a comparison of emission spectrum between a fluorescent material of the second embodiment of the invention and a conventional green phosphor powder. The horizontal axis denotes the illuminating wavelength (the unit is nm) of the excited fluorescent material, the vertical axis denotes the fluorescence intensity (the unit is any unit (a.u.)) emitted by the excited fluorescent material. Also, referring to the upper part and the bottom part of FIG. 9, the conventional green phosphor powder (La_{0.6}PO₄:Ce_{0.25}, Tb_{0.15}) mainly emits a light whose wavelength is about 540 nm. The wavelength of the light emitted by the fluorescent material of the present preferred embodiment (Sr₃La_{0.67}(PO₄)₃:Ce_{0.08}, Tb_{0.25}) ranges between 525 nm and 575 nm, and the main illuminating wavelength is about 540 nm. Both the conventional green phosphor powder and the fluorescent material of the present preferred embodiment can emit a green light with similar luminous intensity.

Referring to Table 3. Each kilogram of conventional phosphor powder La_{0.6}PO₄:Ce_{0.25} Tb_{0.15} must be doped with 144 grams of Ce element and 100 grams of Tb element, while each kilogram of the fluorescent material of the present preferred embodiment Sr₃La_{0.67}(PO₄)₃:Ce_{0.08}, Tb_{0.25} only needs to be doped with 16 grams of Ce element and 57 grams of Tb element, which are respectively 10.81% of the amount of Ce element and 57% of the amount of Tb element doped in the conventional phosphor powder. Compared with the conventional phosphor powder, the fluorescent material of the present preferred embodiment only needs to be doped with a very amount of Ce element (about 1/10) and a very amount of Tb element (about ½) in order to emit a green fluorescence with the same intensity and at the same time keeps the advantages of the phosphate fluorescence such as long durability, excellent thermostability, and small color shift. Moreover, as Tb element is more expensive than the Ce element, the reduction in the doping amount of Tb element and Ce element largely decreases the manufacturing cost.

TABLE 3
A comparison of components between the conventional green phosphor
powder and the fluorescent material of the second embodiment

| | | Fluorescent material |
|---|---|---|
| | | Of The Present |
| | Conventional Phosphor | Embodiment Of |
| | Powder | The Invention |
| Formula | La_{0.6}PO₄:Ce_{0.25}, Tb_{0.15} | Sr₃La_{0.67}(PO₄)₃:Ce_{0.08}, Tb_{0.25} |
| Molecular | 237.25 | 693.08 |
| Weight | | |
| Doping | 351 g/1 kg of Phosphor | 134 g/1 kg of fluorescent |
| Amount of La | Powder | material |
| Doping | 148 g/1 kg of Phosphor | 16 g/1 kg of Fluorescent |
| Amount of Ce | Powder | material |
| Doping | 100 g/1 kg of Phosphor | 57 g/1 kg of Fluorescent |
| Amount of Tb | Powder | material |

Moreover, as the Tb element is more expensive than Ce element, the manufacturing cost of the fluorescent material can be largely decreased by reducing the doping amounts of Tb element and Ce element.

Likewise, the present embodiment provides a fluorescent lamp using the above fluorescent material. Examples of the fluorescent lamp comprise glass tube, fluorescent film and filament coil. The glass tube is filled with mercury and inert gases, wherein the two ends of the glass tube have a filament coil made from wolfram. The fluorescent film is formed on the inner side of the glass tube and at least comprises the above mentioned fluorescent material.

The fluorescent film of the present embodiment can only comprises one of the abovementioned fluorescent materials is for emitting green fluorescence or comprises many kinds of fluorescent materials for emitting the lights with other colors. For example, the fluorescent film can mix a green fluorescent material, a red fluorescent material and a blue fluorescent material for emitting a white light. Such mixed fluorescent materials can be used in compact fluorescent lamp (CFL), hot cathode fluorescent lamp (HCFL), cold cathode fluorescent lamp (CCFL), low-pressure mercury (vapor) discharge lamp, mosquito catcher, and so on.

The fluorescent material and the fluorescent lamp using the same disclosed in the above embodiments of the invention have many advantages exemplified below.

1. The fluorescent material of the present preferred embodiment does not contain any poisonous metal, and no sever damage will occur to the user or environment even when the fluorescent material is leaked.

2. Compared with conventional fluorescent material, the fluorescent material of the present preferred embodiment can emit a light of identical intensity by doping a small amount of rare-earth metal, hence largely reducing the manufacturing cost for the fluorescent material.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fluorescent material being expressed as:
A₃D₁₋ₓ(PO₄)₃:Ce_{X}
wherein, 0<X≦0.5, “A” is selected from Be, Mg, Ca, Sr, Ba, Zn or a combination thereof, and “D” is selected from La, Gd, Sc, Lu, Nd, B, Ga, In or a combination thereof.

2. The fluorescent material according to claim 1, wherein X ranges between 0.03 and 0.1.

3. The fluorescent material according to claim 1, wherein when “A” denotes Sr, “D” denotes La, and X is 0.08.

4. The fluorescent material according to claim 1, wherein the emission wavelength of the fluorescent material is within the range from 320 nm to 400 nm.

5. The fluorescent material according to claim 1, wherein the emission wavelength of the fluorescent material is about 370 nm.

6. The fluorescent material according to claim 1, wherein the fluorescent material further doped with Tb is expressed as:
A₃D_{1-X-Y}(PO₄)₃:Ce_{X}, Tb_{Y}
wherein, 0<Y≦0.6, and the emission wavelength of the fluorescent material is within the range of green light.

7. The fluorescent material according to claim 6, wherein Y ranges between 0.1 and 0.4.

8. The fluorescent material according to claim 6, wherein when “A” denotes Sr, “D” denotes La, X is 0.08, and Y ranges between 0.1 and 0.35.

9. The fluorescent material according to claim 6, wherein the emission wavelength of the fluorescent material is within the range from 525 nm to 575 nm.

10. The fluorescent material according to claim 6, wherein the emission wavelength of the fluorescent material is about 540 nm.

11. A fluorescent lamp, comprising:
a glass tube filled with mercury and inert gases; and
a fluorescent film formed on the inner side of the glass tube, wherein the fluorescent film at least comprises a fluorescent material being expressed as:
A₃D_{1-X}(PO₄)₃:Ce_{X}
wherein, 0<X≦0.5, “A” is selected from Be, Mg, Ca, Sr, Ba, Zn or a combination thereof, and “D” is selected from La, Gd, Sc, Lu, Nd, B, Ga, In or a combination thereof.

12. The fluorescent lamp according to claim 11, wherein X ranges between 0.03 and 0.12.

13. The fluorescent lamp according to claim 11, wherein when “A” denotes Sr, “D” denotes La, and X is 0.08.

14. The fluorescent lamp according to claim 11, wherein the emission wavelength of the fluorescent material is within the range from 320 nm to 400 nm.

15. The fluorescent lamp according to claim 11, wherein the emission wavelength of the fluorescent material is about 370 nm.

16. The fluorescent lamp according to claim 11, wherein the fluorescent material further doped with Tb is expressed as:
A₃D_{1-X-Y}(PO₄)₃:Ce_{X}, Tb_{Y}
wherein, 0<Y≦0.6, and the emission wavelength of the fluorescent material is within the range of green light.

17. The fluorescent lamp according to claim 16, wherein Y ranges between 0.1 and 0.4.

18. The fluorescent lamp according to claim 16, wherein when “A” denotes Sr, “D” denotes La, X is 0.08, and Y ranges between 0.1 and 0.35.

19. The fluorescent lamp according to claim 16, wherein the emission wavelength of the fluorescent material is within the range from 525 nm to 575 nm.

20. The fluorescent lamp according to claim 16, wherein the emission wavelength of the fluorescent material is about 540 nm.

21. The fluorescent lamp according to claim 16, wherein the fluorescent film further comprises a red fluorescent material and a blue fluorescent material.
